(19) United States
(12) Patent Application Publication
(10) Pub. No.: US 2008/0224667 A1
(43) Pub. Date: Sep. 18, 2008

(54) Method for charging battery pack

(76) Inventors: Koji Tanaka, Sumoto-shi (JP); Kenichi Morina, Minami Awaji-shi (JP); Hitoshi Hamaguchi, Sumoto-shi (JP); Hirofumi Hirooka, Sumoto-shi (JP); Toru Morioka, Awaji-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/073,890

(22) Filed: Mar. 11, 2008

(30) Foreign Application Priority Data
Mar. 14, 2007 (JP) 2007-65453

(51) Int. Cl. H01M 10/44; H01M 10/48

(52) U.S. Cl. 320/139; 320/137

(57) ABSTRACT

A method for charging a lithium-ion secondary battery is so designed as to fully charge, with a voltage of the lithium-ion secondary battery being limited to a set voltage. Further, the method for charging the lithium-ion secondary battery is so designed that a degradation level of the lithium-ion secondary battery is detected, and when the degradation is advanced, the battery is fully charged with the set voltage being lowered.

### BACKGROUND OF THE INVENTION

1. Field of the Invention

The present invention relates to a method for charging a lithium-ion secondary battery and, in particular, pertains to a charging method for fully charging a degraded lithium-ion secondary battery in a safe manner.

2. Description of the Related Art

A lithium-ion secondary battery is fully charged by subjecting to a constant-voltage and constant-current charge. The constant-voltage and constant-current charge serves to fully charge the battery first in a constant-current charging operation and then in a constant-voltage charging operation. The first constant-current charging operation is performed until a battery voltage is elevated to a set voltage. When the battery voltage reaches the set voltage, the operation is switched to the constant-voltage charge so that the battery voltage may not be excessively elevated. This is because the voltage of the battery in the charging operation should be prevented from becoming higher than the set voltage. In the constant-voltage charge where the battery is charged with the battery voltage being retained at the set voltage, a charge current of the battery gradually decreases. When the charge current becomes smaller than a set value, the battery is judged to have been fully charged, and the charging operation ceases. The lithium-ion secondary battery is charged with the set voltage for the constant-voltage charging operation being set, for example, in a range between 4.1 V/cell and 4.2 V/cell.

The set voltage for the constant-voltage charging operation affects safety, an available capacity and life time of the lithium-ion secondary battery. When the set voltage is high, it is possible to increase a substantially chargeable capacity, or in other words, a capacity of a fully charged battery becoming fully discharged, but the safety is decreased and the life time is shortened due to a higher probability of liquid leakage or the like. When the set voltage is made lower in order to improve the safety and the life time, the duration of battery use becomes shorter due to a decreased available capacity. FIG. 1 is a diagram showing an available capacity and a cycle life of a lithium-ion secondary battery. In the Figure, a discharge-charge cycle is depicted in the direction of a horizontal axis, while an available capacity is depicted in the direction of a vertical axis. As is apparent from the Figure, the available capacity of the battery at an initial stage can be made large with the set voltage being made high for the battery to be charged. However, when the battery is fully charged at a high voltage with the set voltage being made high, the safety is decreased and the life time becomes shorter. In FIG. 1, characteristics A, B, C and D depict properties of the lithium-ion secondary battery to be charged at various set voltages. In the battery with characteristic A, the battery is fully charged with its set voltage being higher, so that its initial, available capacity becomes larger but its life time becomes shorter. On the contrary, when shifting to characteristics B, C and D, the batteries are fully charged with their set voltages being lower, so that their initial, real capacities are smaller but their cycle lives become longer. As can be seen from the characteristics shown in the Figure, the available capacity and cycle life of the battery indicate contradictory properties, where when the available capacity is made larger with the set voltage being made higher, the cycle life becomes shorter, and when the cycle life is made longer with the set voltage being made lower, the available capacity becomes smaller. In view of this phenomenon, there exists a trade-off between the available capacity and the cycle life, where when one factor is made higher, the other factor becomes lower, without being able to satisfy both factors at the same time.

Charging methods of making the set voltage high for the battery being charged while repeating charge and discharge operations to improve a available capacity are described in laid-open Japanese Patent Application Nos. H9-120843-A (1997), 2000-270491-A and 2005-278334-A.

### SUMMARY OF THE INVENTION

The charging methods described in the above-mentioned Documents are to increase the set voltage of the battery being charged in accordance with the battery getting degraded after repeated cycles of charging and discharging operations. In a lithium-ion secondary battery which is charged with a set voltage being made high, an available capacity will increase. However, since a battery with a lower electric property is the one which is degraded and is reaching its end of life, a higher set voltage for such battery is prone to accordingly increase a probability of liquid leakage, causing decreased safety of the battery. This is because the degradation makes a probability of liquid leakage higher, and such probability of liquid leakage becomes even higher by making the set voltage higher, so that the safety is remarkably decreased. Therefore, when a set voltage is made high for a degraded battery, its available capacity may be increased but its safety cannot be secured, and the battery degradation becomes even more remarkable, which results in a drastic decrease in the available capacity. For this reason, in the method of increasing the set voltage while the battery is charged and discharged, the available capacity may be tentatively increased but the safety of the battery cannot be secured.

The present invention has been made to overcome the above-mentioned disadvantage, and it is the primary object of the invention to provide a method for charging a lithium-ion secondary battery, in which the battery is charged in an ideal state to secure the safety and increase the available capacity of the battery.

The inventive method for charging a lithium-ion secondary battery is configured as described below in order to achieve the above-mentioned object. In the present battery charging method, the lithium-ion secondary battery is fully charge with its battery voltage being limited to a set voltage. Further, in this battery charging method, a degradation level of the lithium-ion secondary battery is detected, and when its degradation is found to be advanced, the battery is fully charged with the set voltage being made low.

The above-described method for charging the lithium-ion secondary battery carries the advantage that while the safety of the battery is secured in charging the battery in an ideal state, the available capacity of the battery can be made larger. This is because the above-described battery charging method is to detect a degradation level of the battery in a state where the lithium-iron secondary battery is fully charged with the battery being limited to a set voltage, and when the degradation is advanced a charging operation is performed with the set voltage being made lower. Since a non-degraded lithium-ion secondary battery is fully charged with the set voltage being made high, a fresh lithium-iron secondary battery is not limited to its available capacity. That is to say, in order to improve the safety of the battery, the available capacity of the fresh battery is not limited. A fresh battery is used with a larger available capacity, and the set voltage is made lower in a degraded state, so that the safety is secured. Further, the charging method of the present invention also realizes the advantage that the contradictory properties of an increased available capacity and longer life time can be achieved. This is because in the above-described charging method, a fresh lithium-ion secondary battery has its available capacity increased with the set voltage being made high, and a battery which is likely to get degraded is prevented from degradation by making the set voltage lower.

The inventive method for charging the lithium-ion secondary battery is capable of detecting a degradation level of the battery, based on any one of an internal resistance of the battery, a chargeable capacity and a cycle number.

The inventive method for charging the lithium-ion secondary battery can switch the set voltage for the constant-voltage charging operation from 4.2 V/cell to 4.1 V/cell when the battery has been degraded to a set degradation level.

The above and further objects of the present invention as well as the features thereof will become more apparent from the following detailed description to be made in conjunction with the accompanying drawings.

### BRIEF DESCRIPTION OF THE DRAWINGS

FIG. 1 is a diagram showing the available capacity and cycle life of a lithium-ion secondary battery;

FIG. 2 is a block diagram showing an example of a battery packs which is charged in the charging method in accordance with an embodiment of the present invention;

FIG. 3 is a graph showing an example of the function of judging the degradation level, based on the internal resistance of the battery;

FIG. 4 is a graph showing an example of the function of judging the degradation level, based on the available capacity of the battery;

FIG. 5 is a graph showing an example of fully charging the battery by switching on/off the switching element for charging a battery;

FIG. 6 is a graph showing another example of fully charging the battery by switching on or off the switching element for charging a battery;

FIG. 7 is a graph showing an example of decreasing the set voltage, based on the degradation level of the battery;

FIG. 8 is a graph showing an example of charging method which mitigates the degradation of the battery;

FIG. 9 is a graph showing another example of charging method which mitigates the degradation of the battery;

FIG. 10 is a graph showing yet another example of charging method which mitigates the degradation of the battery;

FIG. 11 is a graph showing even another example of charging method which mitigates the degradation of the battery; and

FIG. 12 is a graph showing a further example of charging method which mitigates the degradation of the battery.

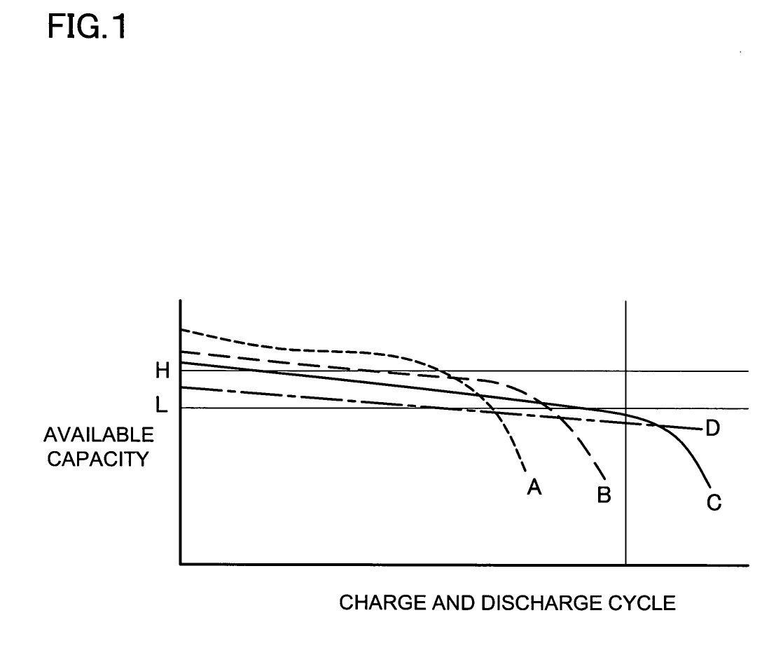

### DETAILED DESCRIPTION OF THE PREFERRED EMBODIMENT(S)

Unlike a conventional method, the battery charging method of the present invention is not to make a set voltage high for a battery being charged while charging and discharging operations are repeated. Contrary to a conventional method, the charging method of the present invention is to make a set voltage lower while the battery charging and discharging operations are repeated. That is to say, in the charging method of the present method, a available capacity is made larger with a set voltage being made high for a battery which is fresh and unlikely to be degraded, while a set voltage is made low for a battery in which an electric property is lowered and likely to be degraded while the charging and discharging operations are repeated, so that the degradation is prevented. In this particular method, an available capacity is made large for a fresh battery which is robustly resistant to degradation, while a battery vulnerable to degradation is charged at such a voltage as to prevent degradation.

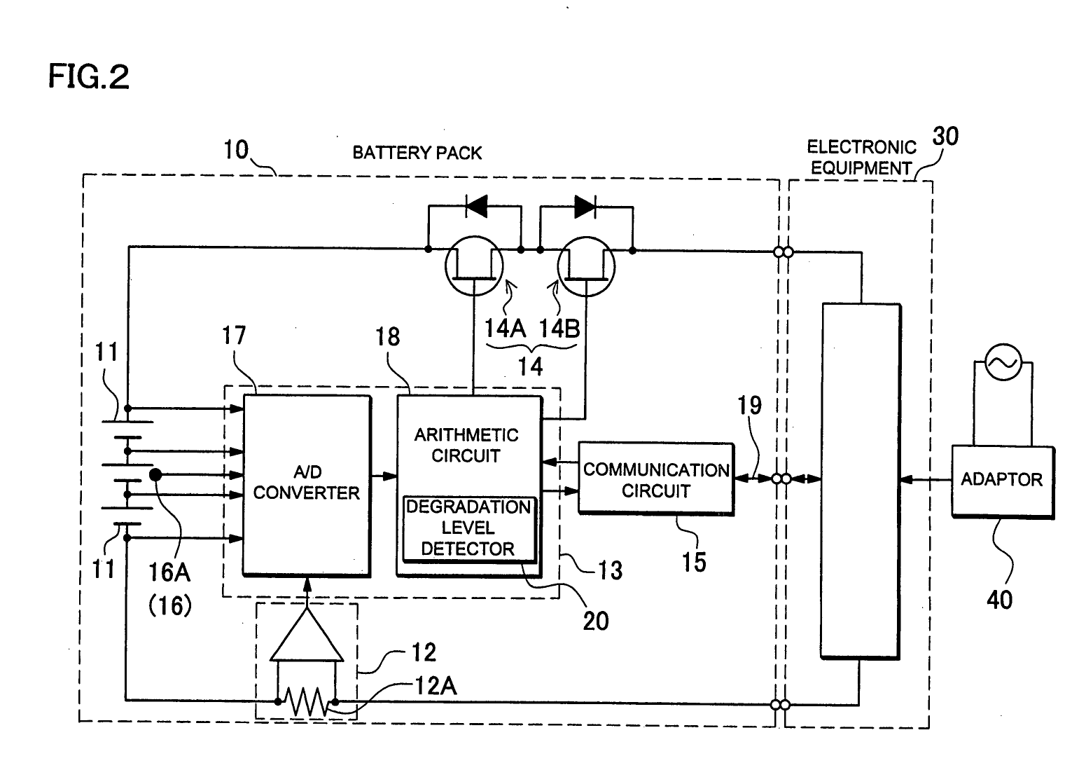

Lithium-ion secondary battery is fully charged by a constant-voltage and constant-current charging operation so as to be charged with the maximum voltage of the battery being limited. FIG. 2 shows a battery pack 10 to be charged in the charging method of the present invention. In FIG. 2, the battery pack 10 is mounted to electronic equipment 30. The electronic equipment 30 is mobile equipment PC. The battery pack 10 is charged by the mobile equipment PC of the electronic equipment 30 to which the battery pack 10 is mounted. The mobile equipment PC is a mobile personal computer like of a notebook type. Usually, the battery pack 10 is detachably mounted to the mobile equipment PC. The battery pack may sometimes be of a built-in type, being structured not to be detached as a power source for the mobile equipment PC. The mobile equipment PC is connected to an adaptor 40 which converts AC commercial power, supplied from a plug socket, to DC power. The adaptor 40 serves to supply the DC power to the mobile equipment PC. The mobile equipment PC is provided with a power supply circuit (not shown) for controlling the electric power supplied from the adaptor 40. The power from the power supply circuit charges the battery pack 10 and also supplies the electric power to a load (side) of the mobile equipment PC. Further, the battery pack 10 supplies the electric power to the mobile equipment PC in a state where the electric power is not supplied from the adaptor 40.

The battery pack 10 includes a chargeable battery 11 composed of a lithium-ion secondary battery, a current detector 12 provided with a current detection resistance 12A for detecting a current flowing at the time of charging and discharging the battery 11, a control circuit 13 provided with a micro processor unit (hereinafter referred to as an MPU) for monitoring and controlling the charging and discharging operations of the battery 11, a switching element 14, being switched on or off by the control circuit 13, for controlling the current flowing to the battery 11, and a communication circuit 15 for communicating with the mobile equipment PC. Further the illustrated battery pack 10 is provided with a temperature detector 16 including a thermistor which serves as a temperature sensor 16A being thermally coupled with the battery 11.

The control circuit 13 incorporates an A/D converter 17 and an arithmetic circuit 18. In the A/D converter 17, a voltage of the battery 11, an output from the current detector 12, and an output from the temperature detector 16 are converted from an analog signal to a digital signal, to be inputted to the arithmetic circuit 18. The arithmetic circuit 18 arithmetically processes the digital signal outputted from the A/D converter 17 and switches on or off the switching element 14. The charge current and discharge current of the battery 11 are integrated to arithmetically process a residual capacity, and a full charge is detected, based on the voltage of the battery 11 to control the switching element 14. Further, like at the time of detecting an abnormal current flowing to the battery 11, an abnormal temperature, and an abnormal voltage, the arithmetic circuit 18 switches off the switching element 14, so that the current is shut off for protection of the battery 11.

Further, the arithmetic circuit 18 is provided with a degradation level detector 20 for detecting a degradation level of the battery 11. The degradation level detector 20 compares a detected degradation level with a set degradation level which has been stored, so that when the detected degradation level is judged to have advanced in excess of the set degradation level, the battery is judged to be in a degraded state. After such judgment has been made, a set voltage for a charging operation is made lower, as will be described below.

It should be noted that, in accordance with the present embodiment, one method is to judge a state of advanced degradation (in terms of the maximum capacity as described below) when a value indicative of a degradation level is smaller, and the other method is to judge a state of advanced degradation (in terms of an internal resistance and cycle number as described below) when a value indicative of a degradation level is greater. And, in the present embodiment, when the detected degradation level exceeds the set degradation level, the degradation is judged to be in an advanced state, which indicates the degraded state of the battery.

The degradation level detector 20 is capable of judging a degradation level in the below-mentioned methods, but it is also possible to judge a degradation level in a method other than these methods. In the present embodiment, at least one of the following methods can be used for judging a degradation level:

(1) a method for detection, based on an internal resistance

(2) a method for detection, based on a maximum chargeable capacity

(3) a method for detection, based on a cycle number of charge and discharge

A plurality of these methods may also be used to judge a degradation level of the battery, based on the most advanced degradation level that is detected by either of these methods.

In the method (1) for detecting the degradation level of the battery, based on an internal resistance, the internal resistance of the battery 11 is detected to judge the degradation level of the battery 11. Since a degraded battery has the nature that the internal resistance increases, the degradation level can be detected, based on the internal resistance. However, since the battery has a smaller chargeable capacity in accordance with the battery being degraded, it is also possible to judge the degradation level by detecting a chargeable, available capacity. The internal resistance (R) of the battery 11 can be calculated in the following equation, by detection of a current and voltage flowing to the battery 11 when the current is flowed to the battery:

R=(E_{ocv}−E_{ccv})/I

where, in the equation, E_{ocv} is a no-load voltage of the battery, E_{ccv} is a battery voltage in a state where a current I flows through, and I designates the current.

The degradation level detector 20 stores a function and a table which determine a degradation level, based on the internal resistance (R) of the battery 11, calculated with the above equation, and judges the degradation level of the battery 11, with the aid of the stored function and table.

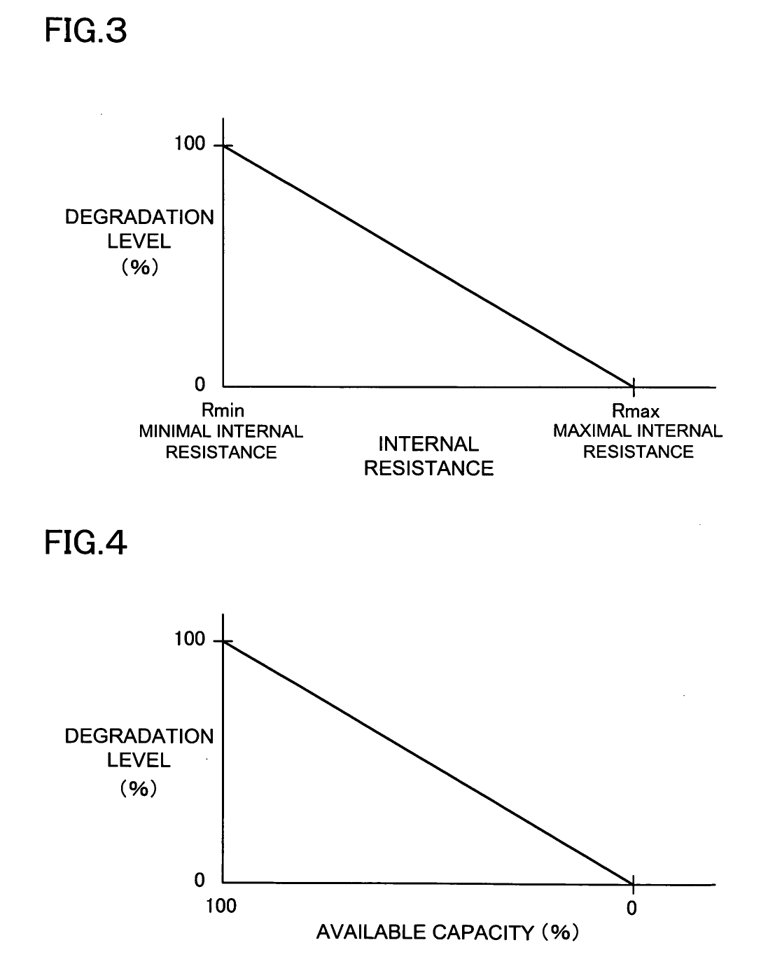

In judging the degradation level, based on the internal resistance (R), a minimal internal resistance (Rₘᵢₙ) of a fresh battery and a maximal internal resistance (Rₘₐₓ) of a dead battery are measured, and when an internal resistance (R) of the battery is equal to the maximal internal resistance (Rₘₐₓ), the battery is judged to be fully degraded and is given a degradation level of 0%. In regard to the degradation level of the battery, a degradation level of a fresh battery is indicated at 100%, while a degradation level of a fully degraded battery is indicated at 0%. FIG. 3 illustrates a function used for the degradation level detector 20 to determine a degradation level, based on the internal resistance of the battery. The Figure shows that a degradation level is linearly changed with respect to the internal resistance, but the degradation level with respect to the internal resistance does not necessarily have to be linearly changed. In addition, in regard to the detected degradation level as mentioned above, when the detected internal resistance of the battery is used and a set value of resistance is used as a set degradation level to be stored in a memory (not shown), the battery can also be judged to be in a degraded state when the detected internal resistance exceeds the set value of resistance.

In the method (2) for detecting a degradation level of a battery, based on a chargeable maximal capacity, the degradation level detector 20 for detecting the degradation level of the battery 11, based on a chargeable, available capacity (=maximal capacity or learning capacity) of the battery 11, detects a capacity gained from a fully discharged state to a fully charged state, and detects the degradation level, based on such capacity. This degradation level detector 20 as well stores a function and table that detect the degradation level, based on the chargeable, available capacity, and converts the capacity to the degradation level, with the aid of the stored function and table. FIG. 4 illustrates a function that the degradation level detector 20 determines a degradation level, based on an available capacity of the battery 11. In this Figure, the degradation level is linearly changed with respect to the available capacity, but the level does not necessarily have to be linearly changed.

Furthermore, the battery can be judged to be in a degraded state when the detected available capacity is used as the detected degradation level described above, when the set, available capacity is used as the stored, set degradation level, or when the detected, available capacity becomes smaller than the set, available capacity.

Here, in regard to the obtained, available capacity (=learning capacity), when it exceeds, over a limit width, the previously calculated total capacity, such available capacity can be made a value within a given limit width. That is to say, in regard to currently calculated available capacity, it is limited within a limit width of +/−20% of the previous value of available capacity. For example, if a 30% decrease is seen in a learning capacity, it should be the available capacity (=learning capacity) of minus 20% because the limit exists. Instead of this arrangement, when the current calculated available capacity (=learning capacity) is used, it is also possible to use the available capacity calculated from an average value having been thus far obtained in a plurality of times (about two to five times, preferably about four times).

Further, in the method (3) for detecting the degradation level of the battery, based on the cycle number of charge and discharge operations, the degradation level detector 20 is so designed that the fully discharged state coming after having fully charged a fully discharged battery, i.e., a battery with its residual capacity of 0%, is counted as one cycle, and that the cycle number of such accumulated cycles is detected, so that the degradation level is detected, based on such cycle number. This degradation level detector 20 as well stores a function and table that detect the degradation level, based on the accumulated cycle number, and such accumulated cycle number is converted to the degradation level, with the aid of the stored function and table. The battery can be judged to be in a degraded state, in regard to the detected degradation level as mentioned above, when such accumulated cycle number is used, when a set cycle number is used as the stored, set degradation level, or when the accumulated cycle number thus detected becomes larger than the set cycle number.

With regard to the cycle, unlike in the above-mentioned, fully discharged state coming after having fully charged a fully discharged battery, the one cycle based on the charge and discharge cycle indicative of repeated charging and discharging operations can also be counted by integrating the charge capacity or the discharge capacity. The counting method, based on the charge capacity, accumulates the integrated value of the charged capacity of the battery which is charged and discharged. Every time when the accumulated amount of the charged capacity reaches the available capacity of the battery at this point, it is counted to be one cycle, and the accumulated cycle number is added, based on the count. For example, in the case of a battery with its present, available capacity of 1000 mAh, when the first charge is made at 500 mAh, the second charge at 200 mAh, and the third charge at 300 mAh, the accumulated amount of the charge capacity reaches 1000 mAh, so that one cycle of charge is judged to have been performed. During this period of time, the battery can also be discharged, and can be fully charged as well. By repeating these charging operations, every time when the cumulative amount reaches the current, available capacity of the battery, the cycle number is added.

Further, instead of the charge capacity, the one cycle can also be counted, based on an accumulated amount of discharge capacity. In this method, actual discharge capacities are accumulated, and every time when the accumulated amount reaches the current, available capacity of the battery, it is counted to be one cycle, and thus a degradation counter is added, based on such count. For example, in the case of a battery with its present, available capacity of 1000 mAh, when the first discharge is made at 500 mAh, the second discharge at 200 mAh, and the third discharge at 300 mAh, the accumulated amount of discharge capacity reaches 1000 mAh, so that one cycle of discharge is judged to have been performed. During this period of time, the battery can also be charged, and can be fully charged as well. After repeating these discharging operations, every time when the accumulated amount reaches the current, available capacity of the battery, the cycle number is thus added.

Further, instead of either one of the charge capacity or the discharge capacity, the one cycle can also be counted, based on the accumulated amount of both the charge capacity and discharge capacity. In this method, an actual charge capacity and discharge capacity are accumulated, and every time when the accumulated amount reaches the double amount of the current, available capacity of the battery, it is counted to be one cycle, and a degradation counter is thus added, based on such count. For example, in the case of a battery with its present, available capacity of 1000 mAh, when the first charge is made at 800 mAh, the first discharge at 500 mAh to follow the previous charge, the second discharge at 200 mAh, the second charge at 200 mAh, and then the third discharge at 300 mAh, the accumulated value of charge capacity reaches 1000 mAh, and the accumulated amount of discharge capacity reaches 1000 mAh, thus totaling an accumulated value of charge and discharge to be 2000 mAh, so that one cycle of charge is judged to have been performed.

The switching element 14 is a MOSFET. The MOSFET has a parasitic diode. The MOSFET having the parasitic diode is, in an OFF state, capable of allowing a reverse current to flow by means of the parasitic diode. In the switching element 14 composed of the MOSFET, a switching element 14A, for a discharging operation, to shut off the discharge current of the battery 11 is connected in series to a switching element 14B, for a charging operation, to shut off the charge current.

When a voltage of the battery 11 being discharged comes down to the minimal voltage, the switching element 14A for a discharging operation is switched from ON to OFF by means of the control circuit 13 and shuts off a discharge current of the battery 11. The switching element 14A, for a discharging operation, now in an OFF state is able to flow a charge current by means of the parasitic diode. Therefore, when the voltage of the battery 11 increases due to a flow of the charge current, the switching element 14A for a discharging operation is switched from OFF to ON to be able to perform a discharging operation.

The switching element 14B for a charging operation is switched from ON to OFF by means of the control circuit 13 and controls the charge current of the battery 11 to fully charge. When the battery 11 is fully charged, the switching element 14B for a charging operation is held in an OFF state. The switching element 14B, for a charging operation, now in an OFF state is able to flow a discharge current by means of the parasitic diode. Therefore, when the voltage of the battery 11 decreases due to a flow of the discharge current, the switching element 14B for a charging operation is switched from OFF to ON. The switching element 14B, for a charging operation, now in an ON state has a smaller internal resistance than does the parasitic diode. Therefore, a voltage drop of the charge current is small, and the electric power of the battery 11 is effectively supplied to the mobile equipment PC being a load (side), while preventing a heat from being generated in the switching element 14B for a charging operation.

The control circuit 13, in a state of charging the battery 11, controls the switching element 14B for a charging operation. When a voltage of the battery 11 is lower than a set voltage, the control circuit 13 holds the switching element 14B, for a charging operation, in an ON state, and performs a constant-current charge for the battery 11. Subsequently, when the voltage of the battery 11 is elevated to the set voltage, the control circuit 13 switches on or off the switching element 14B for a charging operation, so that the battery 11 is fully charged by means of pulsed charge.

The control switch 13 for switching on or off the switching element 14B, for a charging operation, at a set voltage provides for a difference between the set voltages for switching on or off, that is, a difference between an ON set voltage and an OFF set voltage, namely a hysteresis error, so that the switching element 14B for a charging operation is switched on or off. In other words, in the switching element 14B for a charging operation, a switching-on set voltage is made lower than a switching-off set voltage. This is because when the switching element 14B for a charging operation is switched on or off at the same level of set voltage, the switching element 14B is switched off immediately after being switched on. The different between the ON set voltage and the OFF set voltage, namely a hysteresis voltage, is set at such a voltage as may allow the switching element 14B for a charging operation to be switched on to charge the battery 11 for a given period of time and then may allow the switching element 14B for a charging operation to be switched off. Since the battery 11 has an internal resistance, a voltage of an output terminal of the battery 11 increases when the switching element 14B for a charging operation is switched on to start its charging operation. This is because a voltage drop caused by the internal resistance is added to the battery voltage, resulting in producing a voltage of the output terminal. Therefore, when the switching element 14B for a charging operation is switched from OFF to ON, the addition of a voltage drop caused by the internal resistance, to the battery voltage, causes the voltage of the output terminal of the battery 11 to be elevated, although the voltage of the battery itself is not elevated. Therefore, if the set voltage is given at the same level both for switching on and switching off the switching element 14 for a charging operation, when the switching element 14B for a charging operation is switched from OFF to ON, the addition of the voltage drop caused by the internal resistance, to the battery voltage, causes the voltage of the output terminal to be elevated, and immediately the switching element 14B for a charging operation will be switched back to OFF. In such a state, the battery 11 cannot be charged. Therefore, the battery 11 is charged when a hysteresis (error) is provided between the set voltages in order to avoid the harmful effects caused by the internal resistance. As such, the hysteresis voltage is set to be larger than the voltage drop caused by the internal resistance of the battery 11. The voltage drop caused by the internal resistance of the battery 11 is a product of the internal resistance and the charge current. Therefore, the voltage drop caused by the internal resistance is varied by the internal resistance and the charge current. When the internal resistance becomes larger and also when the charge current becomes larger, the voltage drop becomes correspondingly larger. In view of this phenomenon, and when a consideration is paid to the internal resistance of the battery 11 and the charge current as well as to a resolution of the A/D converter 17, the hysteresis voltage is set, for example, in a range between 1 mV and 50 mV. In a state where the switching element 14B, for a charging operation, to be switched OFF, the voltage drop caused by the internal resistance is negligible. Accordingly, the voltage of the output terminal in a state where the switching element 14, for a charging operation, to be switched off, namely OCV (Open Circuit Voltage), is a substantial battery voltage.

In the control circuit 13, as described below, the switching element 14B for a charging operation is switched on or off to limit the voltage of the battery 11, which is to be charged, to a set voltage for charging the battery, and a pulsed charge is also provided while the set voltage is lowered corresponding to a degradation level of the battery 11.

In lowering the set voltage for charging the battery, instead of such pulsed charge, it is also possible to lower the set voltage for charging the battery, in a power supply circuit (not shown) within the electronic equipment 30, by communicating to the electronic equipment 30 to tell that a degradation has advanced or that the set voltage has to be lowered in view of an advanced degradation.

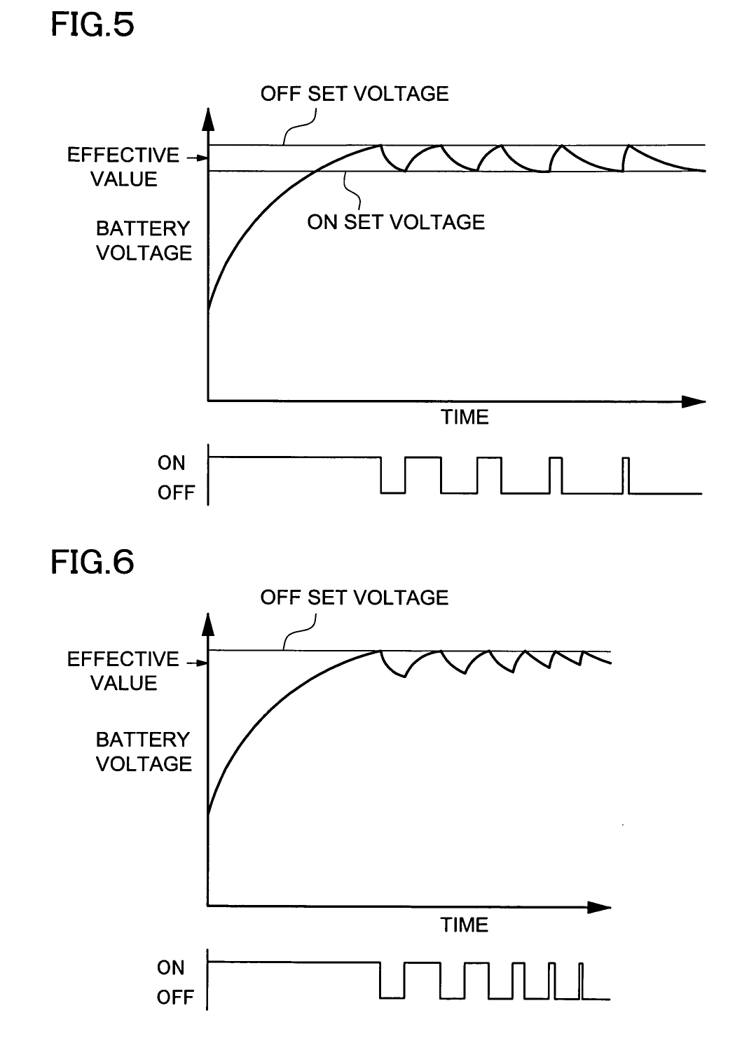

In the pulsed charge, by way of limiting an effective value (as will be described below) of the charge voltage of the battery 11 to the set voltage, or limiting OCV of the battery 11 to the set voltage, the switching element 14B for a charging operation is switched on or off to fully charge the battery 11 by means of a constant-voltage charge. That is to say, in the pulsed charge, when the voltage of the battery 11 is elevated to the OFF set voltage, the switching element 14B for a charging operation is switched off, and subsequently when the voltage of the battery 11 comes down to the ON set voltage, or when a given period of time elapses, the switching element 14B for a charging operation is switched on. These actions or behaviors are repeated until the battery 11 is fully charged. Such charging state is shown in FIG. 5 and FIG. 6.

FIG. 5 shows the state that when the battery voltage is elevated to the OFF set voltage the switching element 14B for a charging operation is switched off, and subsequently when the battery voltage is lowered to the ON set voltage the switching element 14B for a charging operation is switched on to charge the battery. In this state, the effective value of the charge voltage becomes, roughly, a middle value between the OFF set voltage and the ON set voltage, becoming a substantially average value between the OFF set voltage and the ON set voltage. That is to say, the battery 11 is charged at the set voltage which is the effective value of the charge voltage. If such pulsed charge is used, the set value of the charge voltage can be lowered, by the same voltage value, by lowering both the OFF set voltage and the ON set voltage. For example, by way of lowering the set voltage of the charge voltage by 1 mV, both the OFF set voltage and the ON set voltage may only be set by lowering by 1 mV. FIG. 6 shows the state that when the battery voltage is elevated to the OFF set voltage the switching element 14B for a charging operation is switched off, and when a given duration of time elapses the switching element 14B for a charging operation is switched on to charge the battery such that the effective value of the charge voltage of the battery 11 may become the set voltage.

When the switching element 14B for a charging operation is switched on or off to perform pulsed charge, an average current is lowered correspondingly as the battery 11 is fully charged. This is because as the battery 11 is fully charged, duration of OFF time correspondingly becomes longer. When the average current for charging the battery 11 becomes as small as a given value, the control circuit 13 judges the battery 11 to have been fully charged and stops charging the battery. As shown in FIG. 2, in the case of the battery pack 10 in which a plurality of batteries 11 are interconnected in series, the control circuit 13 controls the switching element 14B, for a charging operation, to perform charge such that the voltage of the battery 11 having the highest battery voltage may not exceed the set voltage, or such that a total voltage of the batteries 11 interconnected in series, namely, the output voltage of the battery pack 10 may not exceed the set voltage. In this manner, by performing the pulsed charge, the effective value of the charge voltage applied on the battery 11 can be reduced, that is, the set voltage for charging the battery 11 can be reduced.

As described above, in a state where a battery voltage is low and in a state where the voltage is not elevated to the set voltage, the control circuit 13 performs constant-current charge to efficiently charge the battery within short time. Therefore, in the charging method of the present invention, the constant-current charge is performed preferably at an initial stage of starting the charge, that is, until the battery voltage is elevated to the set voltage, and subsequently the constant-voltage charge is performed to fully charge the battery, so that the battery can be fully charged efficiently within short time. In the charging method of the present invention, however, it is also possible that the constant-voltage charge is performed from the initial stage of starting the charge to fully charge the battery.

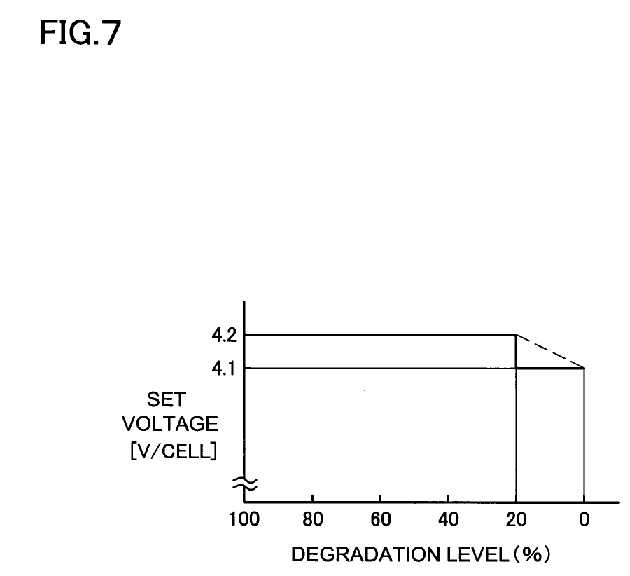

When the control circuit 13 sets the voltage to be high for fully charging the battery 11, the available capacity valid until the battery 11 is fully discharged can be made larger, but the safety cannot be secured for the degraded battery 11, and the life time also becomes shorter. As shown in FIG. 7, in the control circuit 13, the set voltage of the battery 11 to be fully charged is lowered correspondingly as the battery 11 gets degraded. As shown in FIG. 7, the control circuit 13, in which the set voltage of the battery 11 to be charged is varied according to the degradation level of the battery 11, allows the set voltage to be lowered correspondingly as a probability of liquid leakage becomes higher due to the degradation of the battery 11.

As shown in FIG. 7, in the control circuit 13, in which the battery 11 is charged at the lower set voltage, the set voltage is maintained at 4.2 V until the degradation level of the battery 11 reaches a given value (about 50%-10% for example, preferably about 40%-20%, about 40% by way of an example), and subsequently the set voltage is lowered to 4.1 V. The degradation level of the battery 11 is determined by the above-mentioned internal resistance, available capacity or cycle number.

Instead, when the degradation level of the battery 11 reaches a given value, subsequently the set voltage for charging the battery may gradually be lowered, as indicated by a chain line in FIG. 7.

In the above-described method, the control circuit 13 incorporated in the battery pack 10 controls the switching element 14B, for a charging operation, to fully charge the battery 11. However, the charging method of the present invention can also fully charge the battery by controlling the switching element 14B, for a charging operation, in the battery pack 10, by using a charge circuit (not shown) incorporated in the electronic equipment 30 such as the mobile PC with the battery pack 10 being mounted to. Further, by incorporating a charge circuit, for fully charging a battery, in the mobile equipment PC, it also becomes possible to fully charge the battery by controlling the charge of the battery incorporated in the battery pack. Also in equipment for fully charging the battery by means of the charge circuit of the mobile equipment PC, the battery can be fully charged while the charging operation is controlled by both of the mobile equipment PC and the battery pack. In this case, the set voltage, at which the charge circuit of the mobile equipment PC detects a full charge of the battery and stops the charging operation, is made lower than the voltage at which the control circuit of the battery pack detects a full charge of the battery and stops the charging operation. In this method, even when there occurs anomalousness in the charge circuit of the mobile equipment PC, the battery can be fully charged by maintaining the battery at the set voltage by means of the control circuit of the battery pack and the switching element for a charging operation.

In the system where the charge circuit of the electronic equipment 30 controls the switching element 14B, for a charging operation, of the battery pack 10, the battery pack 10 and the mobile equipment PC are interconnected via a communication circuit 19. The illustrated battery pack 10 incorporates a communication circuit 15. The communication circuit 15 of the battery pack 10 is connected via the communication circuit 19 to the mobile equipment PC. The mobile equipment PC controls, through the communication circuit 19 and the communication circuit 15, the switching element 14B, for a charging operation, of the battery pack 10. The communication circuit 15 inputs a signal controlling the switching element 14B, for a charging operation, to the control circuit 13. Further, the communication circuit 15 transmits information for the charge circuit of the electronic equipment 30 to control the switching element 14B, for a charging operation, to be switched on or off, that is to say, the battery voltage, the current for charging and discharging the battery 11, etc. to the mobile equipment PC being the electronic equipment 30. The charge circuit of the mobile equipment PC controls the switching element 14B, for a charging operation, by means of the information transmitted via the communication circuit 15, or controls the switching element (not shown), for a charging operation, incorporated in the charge circuit to fully charge the battery.

Further, with regard to reducing the set voltage for charging the battery, as described above, an explanation was made that the set voltage is reduced by performing the pulsed charge. Instead of this procedure, by using the above-mentioned communication circuit 15, the set voltage of the charge voltage in the charge circuit of the electronic equipment 30 can also be reduced.

Further, in a charging operation, a degradation of a battery can be mitigated by using the following charging method.

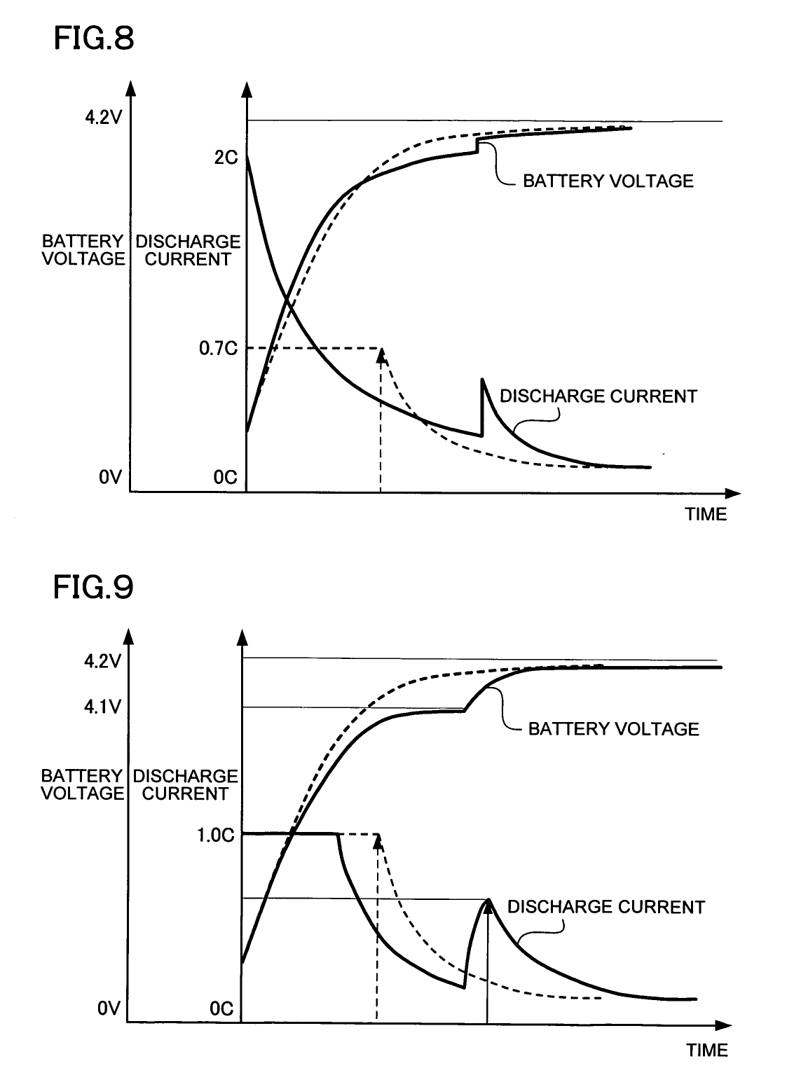

In the charging method as shown in FIG. 8, a charging operation is performed by controlling a charge current to become smaller correspondingly as the battery is charged, in other words, as a charging rate of the battery becomes higher. In this charging method, the degradation is mitigated by controlling a charge current rate with respect to a residual area of an electrode plate which is able to react. For example, suppose that a constant-current and constant-voltage charge is performed with the charge current at 0.5 C. If the charging rate is 0% (a residual area of the electrode plate which is able to react is 100%), when the charge current rate per area which was 0.5 C grows up to the size equivalent to 1.0 C at the charging rate of 50% (a residual area of the electrode plate which is able to react is 50%). At this time, when a current value is made half, it is possible to secure the charge current rate per residual area of the electrode plate available at the initial stage of the charging operation. The equation of such a current as is constant per unit area, for example, 2 C is described as follows.

charge current I=2−2×x[C]

where x is a charging rate, which is indicative of 0% when x=0 and 100% when x=1.

Further, since the charge current subjected to time integration becomes a charging rate, the following equation can be obtained.

$$\begin{matrix}charging rate x ( t ) = \int ( 2 - 2 \times x ) d t \\ = 2 t - 2 \times x \times t + A\end{matrix}$$

where the initial condition x(t=0)=0 leads to A=0, and to sum up the above, the following equation is obtained.

charging rate x(t)=2t/(1+2t).

In FIG. 8, a conventional constant-voltage and constant-current charge is indicated by a chain line, and a control of a charge current per unit area is indicated by a solid line. In a conventional method of charging at a current of 0.7 C, the charge is made at 0.7 C per unit area at the time when the charging operation is started (a residual area which is able to react is 100%), while the charge is made at 0.35 C per unit area at a charging rate of 80% (a residual area which is able to react is 20%) when switched to a constant voltage. On the other hand, in the present example/embodiment, a charge is aimed to be made at 2 C in a controlling method of a charge current per unit area, and the charge current is made hyperbolically small corresponding to a charging rate (charging time) such that a charge is made at 2 C at the time when the charging operation is started (a residual area which is able to react is 100%), at 1.2 C (2 C per unit area) at a charging rate of 40% (a residual area which is able to react is 60%), at 0.6 C (2 C per unit area) at the time when the battery voltage is elevated to the set voltage at the charging rate of 70% (a residual area which is able to react is 30%), that is, at the time when switched to a constant-voltage charge. When the control of the charge current per unit area is continued until a full charge, the charge current is to limitlessly lowered and the charge time is prolonged. Therefore, as is done in FIG. 8, when the charging rate exceeds a certain level, for example, after the charging rate exceeds 80%, it is possible to return to a conventional constant-voltage and constant-current control. A rate of a charge current per a unit area can also be made small corresponding to a lowered ion propagation speed in an electrolytic solution at a low temperature by way of an example. Further, the control of the charge current rate can also be so designed that the charge current is reduced in a step-like line form, or in a curved line form. Here, the charging rate of the battery can be judged, based on a charge capacity, battery voltage, charge time, etc. with respect to a fully charged capacity.

In this charging method, unlike a conventional constant-current and constant-voltage charge, the charging operation is performed by controlling the charge current to become smaller until the battery voltage is elevated to a given set voltage, and when the battery voltage is elevated to the set voltage, the charging operation is performed by switching to a constant-voltage charge. For this reason, when compared with a conventional charging method as indicated by the chain line in FIG. 8, the present charging method is able to charge the battery by making the charge current smaller in an area where the battery voltage is high, while mitigating the degradation of the battery. It should be noted that the present charging method can be performed, for example, by a battery charger which is able to dynamically control the charge current.

Further, in the charging method shown in FIG. 9, the battery is initially subjected to a constant-current and constant-voltage charge at a lower set voltage, and then subjected to a constant-current and constant-voltage charge after switching to a higher set voltage. In this charging method, in a state where a constant-current and constant-voltage charge is performed at a lower set voltage, when the charge current is limited to a certain extent when the charged state of the battery is in an area of a constant-voltage charge, the charging operation is switched to a higher set voltage. In the charging method shown in FIG. 9, it is also possible that a lower set voltage at an initial stage of charging operation is set at 3.8-4.2 V, and a higher set voltage after being switched is set at 3.9-4.35 V.

In this charging method, the constant-current and constant-voltage charge is performed, in advance, at a lower set voltage, and then the constant-current and constant-voltage is performed at a higher set voltage from in a state that the constant current is limited to a certain extent in the area of the constant-voltage charge. As such, immediately after the set voltage is changed, the charging operation is performed in the area of the constant-current charge which is then switched to the constant-voltage charge, so that, before and after the changed mode, the charge current can be made smaller in the area where the battery voltage is high. Therefore, when compared with a conventional charging method indicated by a chain line in FIG. 9, the present charging method also allows the battery to be charged while mitigating the degradation of the battery by making the charge current smaller in the area where the battery voltage is high. It should be noted that this method can be realized by a battery charger in which the charge voltage can be varied at several steps for example. In particular, a battery charger is applicable in which the charge voltage can be varied at several steps but the current value is fixed. For example, a battery charger is applicable in which the charge voltage can be varied at two steps of a quick charge operation (usually at 4.2 V/cell) and a pre-charge operation (at a little lower voltage) but the charge current can be set at a single step only.

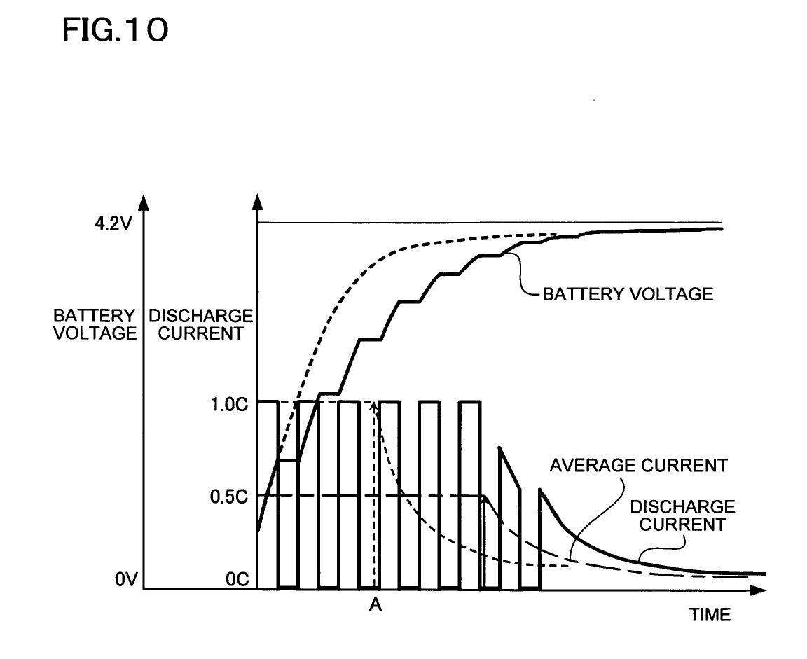

Further, in the charging method shown in FIG. 10, an average charge current is lowered by charging intermittently so as to make a substantial/virtual charge current small. In this charging method, unlike the charging method shown in FIG. 8 and FIG. 9, the substantial/virtual current in the area where the battery voltage is high is made small by repeating the on or off operation of charging, without changing the charge current and the charge voltage. In the charging method indicated by a solid line in FIG. 10, an ON time and an OFF time in the charging operation are made equal, so that the substantial/virtual charge current is made half of the charge current (1 C) in a conventional charging method indicated by a chain line in the Figure. In the present charging method, however, the average current can also be adjusted by changing a duty of the ON or OFF in the charging operation. For example, it is possible that the ratio of the ON time to the OFF time is made larger to make the average current large, or alternatively that the ratio of the ON time to the OFF time is made smaller to make the average current small. In the present method, it is possible to control the ON/OFF in the charging operation so that the average charge current is, for example, in the range of 0.2 C to 0.8 C.

In this charging method as well, when compared with a conventional method in FIG. 10 where the dot-lined voltage and current (the current is lowered from the constant current at the point of Time A), the battery can be charged by making the substantial/virtual charge current small in the area where the battery voltage is high, while mitigating the degradation of the battery. For audience's information (By way of reference), it has been confirmed that the speed of degradation of the battery charged by the control as indicated by a dotted line in FIG. 10 (the average current value indicated by a chain line in the Figure) approaches the speed of degradation of the battery subjected to the constant-current and constant-voltage charge using such average current value instead of the pulsed charge. It should be noted that, in the present charging method, the control can also be realized by a treatment in the battery pack, when a battery charger is applied in which the charge voltage and the charge current cannot be changed together. It should be further noted that, instead of the pulsed charge, the initial charging operation can be performed by means of the constant current but not the pulsed current, and then the pulsed charge (the current value at the time of pulsed charge is at the same level as the current at the time of constant current, or at a value reduced to a level of 50-80%) is applicable from in the middle of the area of constant current charge.

Further, when the charge control shown in the above FIG. 8 through FIG. 10 can be performed on the electric equipment (personal computer) side or on the battery pack side, it is possible to selectively employ such electric equipment or battery pack for mitigating a cycle degradation by making the charge current small in the area of high voltage, without changing the circuit of the battery charger.

Incidentally, as a method of safely and efficiently charging the voltage for a multitude of batteries interconnected in series, there have been devised a variety of methods of charging operation by feeding back the battery voltage for each of series connections instead of feeding back a total voltage for the whole lot of interconnected batteries. In a conventional method, however, there arise concern about the safety and degradation of a battery at a low temperature or at a high temperature, because a particular attention is not paid to the temperature information regarding the battery. In regard to a voltage measurement as well, there is a certain extent of limitation to improving accuracy in detecting a voltage, because a property such as a resistive potential division is linear. As such, a charging method shall be described below to overcome such problems.

In this charging method, the battery is charged by feeding back the battery voltage separately in each series connection, and the charging operation is performed by adjusting the charge voltage and charge current in accordance with a battery temperature. This charging method is so designed that the battery temperature is detected to charge the battery while the charge voltage and the charge current are controlled at a given value in accordance with the detected temperature of the battery. In this charging method, for example, when the detected temperature of the battery is found to be within a set range the charge voltage and charge current are raised to charge the battery, and when the battery temperature is found to be beyond the set range the charge voltage and the charge current are lowered to charge the battery. Here, the range set for the battery temperature can be, for example, 0° C.-15° C. at the lowest and 35° C.-50° C. at the highest.

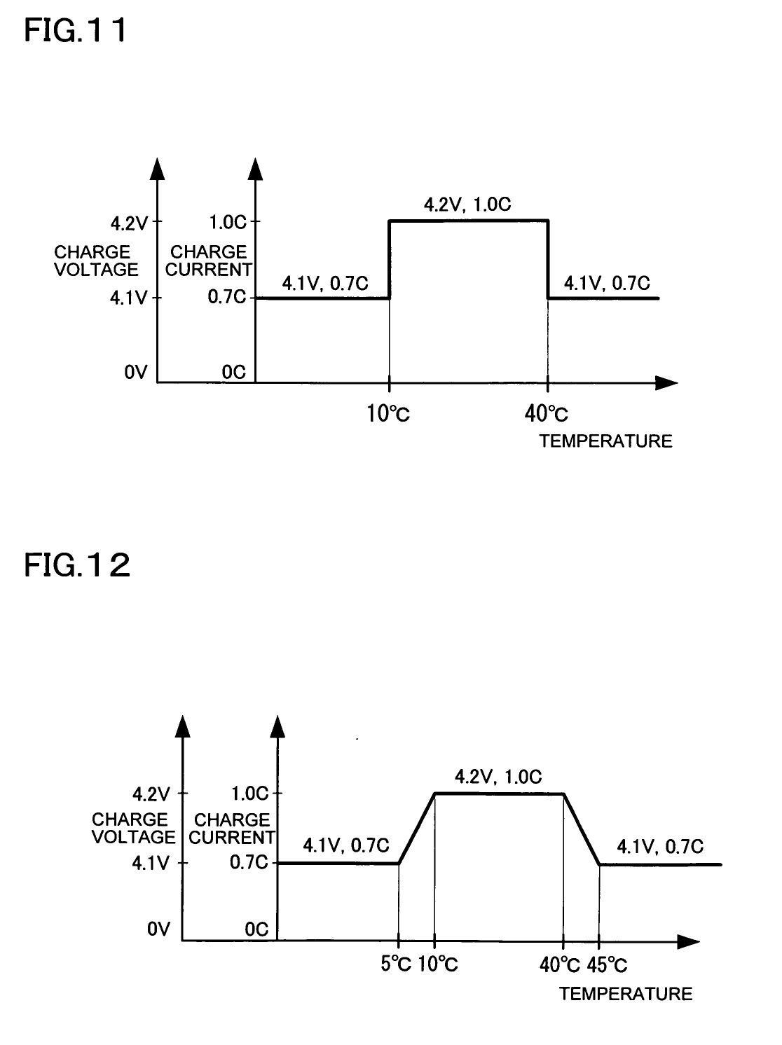

FIG. 11 and FIG. 12 respectively show an example of controlling the charging voltage and the charging current in accordance with the battery temperature. In the charging method shown respectively in these Figures, the range set for the battery temperature is 10° C.-40° C., and when a detected temperature of the battery is within this set range the charging operation is performed with the charge voltage of 4.2 V and with the charge current of 1.0 C. Further, when the battery temperature is beyond the set range, the charging operation is performed with both the charge voltage and the charge current being controlled to be smaller. However, when the battery temperature is beyond the set range, the charge voltage alone can be lowered, or alternatively the charge current alone can also be lowered. Here, in the control mode shown in FIG. 11, the charge voltage and the charge current are changed in a step-like line form at the lowest temperature (10° C.) and the highest temperature (40° C.), each of which is a boundary line of the set range. When the battery temperature is beyond this set range, the charging operation is performed with the charge voltage being lowered to 4.1 V and with the charge current being lowered to 0.7 C. Contrarily, in the control mode shown in FIG. 12, the charge voltage and the charge current are not changed in a step-like line form at the lowest temperature (10° C.) and the highest temperature (40° C.), each of which is a boundary line of the set range, but when the battery temperature is below 5° C. or above 45° C., the charge voltage is lowered to 4.1 V and the charge current is lowered to 0.7 C. When within a range of 5° C.-10° C. and a range of 40° C.-45° C., the charge voltage and the charge current are made linearly smaller. However, the charge voltage beyond the range set for the battery temperature can also be set to be between 0.20 V and 0.05 V less than the charge voltage within the set range, while the charge current beyond the set range can also be set to be between 0.5 C and 0.1 C less than the charge current within the set range.

As described above, by adjusting the charge voltage and the charge current in accordance with the battery temperature, when the battery temperature is within a set range, in other words, when the battery can be charged in a normal manner, the charge capacity can be made larger within short time; in the battery with its battery temperature being beyond the set range, it is possible to improve the safety and restrain the degradation of the battery.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2007-65453 filed in Japan on Mar. 14, 2007, the content of which is incorporated herein by reference.

What is claimed is:

1. A method for fully charging a lithium-ion secondary battery with a voltage being limited to a set voltage, comprising:
detecting a degradation level of the lithium-ion secondary battery during charging of the lithium-ion battery; and
lowering the set voltage to fully charge the lithium-ion battery if the advanced degradation is detected.

2. The method of charging the lithium-ion secondary battery as recited in claim 1, wherein the degradation level of the battery is detected, based on an internal resistance of the battery.

3. The method of charging the lithium-iron secondary battery as recited in claim 2, wherein the degradation level of the battery is detected by means of a function which determines the degradation level, based on the internal resistance of the battery.

4. The method of charging the lithium-iron secondary battery as recited in claim 2, wherein the degradation level of the battery is detected by means of a table which determined the degradation level, based on the internal resistance of the battery.

5. The method of charging the lithium-iron secondary battery as recited in claim 2, wherein the degradation level of the battery is detected, based on the internal resistance of the battery, with a judgment of a minimal internal resistance of a fresh battery and a maximal internal resistance of a dead battery.

6. The method of charging the lithium-iron secondary battery as recited in claim 5, wherein when the internal resistance of the battery reaches the maximum internal resistance the battery is judged to be fully degraded with the degradation level of 0%.

7. The method of charging the lithium-iron secondary battery as recited in claim 1, wherein a degradation level of a fresh battery is graded to be 100%, and a degradation level of a fully degraded battery is graded to be 0%.

8. The method of charging the lithium-iron secondary battery as recited in claim 3, wherein the function used in determining the degradation level, based on the internal resistance of the battery, is a function in which the degradation level is changed linearly with respect to the internal resistance.

9. The method of charging the lithium-iron secondary battery as recited in claim 2, wherein the internal resistance of the battery is detected and a degrading internal resistance is compared with a set value of resistance at a set degradation level which is stored in advance, and when the detected internal resistance exceeds the set value of resistance the battery is judged to be in a degraded state.

10. The method of charging the lithium-iron secondary battery as recited in claim 1, wherein the degradation level of the battery is detected, based on a chargeable capacity.

11. The method of charging the lithium-iron secondary battery as recited in claim 10, wherein a capacity is detected in a range from a fully discharged state to a fully charged state, and the degradation level is detected, based on such capacity.

12. The method of charging the lithium-iron secondary battery as recited in claim 10, wherein a function for detecting the degradation level, based on a chargeable, available capacity, is stored, and the capacity is converted to the degradation level, based on the stored function.

13. The method of charging the lithium-iron secondary battery as recited in claim 10, wherein a table for detecting the degradation level, based on a chargeable, available capacity, is stored, and the capacity is converted to the degradation level, based on the stored table.

14. The method of charging the lithium-iron secondary battery as recited in claim 10, wherein a set, available capacity at a set degradation level is stored, and when a detected, available capacity is smaller than the set, available capacity, the battery is judged to be in a degraded state.

15. The method of charging the lithium-iron secondary battery as recited in claim 1, wherein the degradation level of the battery is detected, based on a cycle number.

16. The method of charging the lithium-iron secondary battery as recited in claim 15, wherein a state, where a fully discharged battery is fully charged and then again the battery is fully discharged, is counted to be one cycle, and wherein the cycle number of accumulating such cycle is detected, so that the degradation level is detected, based on the cycle number.

17. The method of charging the lithium-iron secondary battery as recited in claim 16, wherein a function for detecting the degradation level, based on the accumulated cycle number, is stored, and wherein the accumulated cycle number is converted to the degradation level, based on the stored function.

18. The method of charging the lithium-iron secondary battery as recited in claim 16, wherein a table for detecting the degradation level, based on the accumulated cycle number, is stored, and wherein the accumulated cycle number is converted to the degradation level, based on the stored table.

19. The method of charging the lithium-iron secondary battery as recited in claim 10, wherein every time when an accumulated amount of charge capacity reaches an available capacity of the battery, it is counted to be one cycle, thereby detecting the degradation level of the battery.

20. The method of charging the lithium-iron secondary battery as recited in claim 10, wherein every time when an accumulated amount of discharge capacity reaches an available capacity of the battery, it is counted to be one cycle, thereby detecting the degradation level of the battery.

21. The method of charging the lithium-iron secondary battery as recited in claim 10, wherein an accumulated amount of a charge capacity and discharge capacity is counted to be one cycle, thereby detecting the degradation level of the battery.

22. The method of charging the lithium-iron secondary battery as recited in claim 1, wherein when the battery is degraded to a set degradation level, a set voltage of a constant-voltage charge is switched from 4.2 V/cell to 4.1 V/cell.

23. The method of charging the lithium-iron secondary battery as recited in claim 1, wherein the battery is subjected to pulsed charge while a set voltage is lowered in accordance with a degradation level of the battery.

24. The method of charging the lithium-iron secondary battery as recited in claim 23, wherein when a voltage of the battery is elevated to an OFF set voltage a charging operation is stopped, and subsequently when the voltage of the battery is lowered to an ON set voltage the charging operation is resumed, whereby such operation is repeated to perform pulsed charge.

25. The method of charging the lithium-iron secondary battery as recited in claim 23, wherein when a voltage of the battery is elevated to an OFF set voltage a charging operation is stopped, and subsequently when a given duration of time elapses the charging operation is resumed, whereby such operation is repeated to perform pulsed charge.

26. The method of charging the lithium-iron secondary battery as recited in claim 1, wherein a charging operation is performed by making the charge current hyperbolically small corresponding to a charging rate (charging time).

27. The method of charging the lithium-iron secondary battery as recited in claim 1, wherein a charging operation is performed by making a charge current smaller in a step-like line corresponding to a charging rate (charging time).

28. The method of charging the lithium-iron secondary battery as recited in claim 1, wherein the battery is initially subjected to a constant-current and constant-voltage charge at a lower set voltage, and then subjected to a constant-current and constant-voltage charge after switching to a higher set voltage.

29. The method of charging the lithium-iron secondary battery as recited in claim 28, wherein a lower set voltage at an initial stage of charging operation is set at 3.84.2 V, and a higher set voltage after being switched is set at 3.9-4.35 V.
